(19) United States
(12) Patent Application Publication
(10) Pub. No.: US 2009/0068008 A1
(43) Pub. Date: Mar. 12, 2009

(54) FASTENING STRUCTURE AND ROTARY VACUUM PUMP

(75) Inventor: Kouta OISHI, Kyoto-shi (JP)

Correspondence Address: SUGHRUE MION, PLLC, 2100 PENNSYLVANIA AVENUE, N.W., SUITE 800, WASHINGTON, DC, 20037, US

(73) Assignee: SHIMADZU CORPORATION, Kyoto-shi (JP)

(21) Appl. No.: 11/851,731

(22) Filed: Sep. 7, 2007

(51) Int. Cl. F04D 29/60; F16B 43/00; F16B 35/00

(52) U.S. Cl. 415/213.1; 411/337; 411/378

(57) ABSTRACT

Disclosed is a fastening structure for fastening a gas inlet flange of a turbo-molecular pump by a bolt to a flange of a target unit that will be subjected to a vacuum. The gas inlet flange has a slot-shaped bolt hole formed at a position adjacent to an outer peripheral edge thereof in such a manner that a longitudinal direction of the slot-shaped bolt hole approximately conforms to a direction tangential to the circumference of the gas inlet flange. A cushioning member made of foamed metal is disposed in the bolt hole. Even if an impact force occurs due to failure in the turbo-molecular pump, the cushioning member can receive the impact force to be applied from the gas inlet flange to the bolt.

### BACKGROUND OF THE INVENTION

1. Field of the Invention

The present invention relates to a fastening structure suitable for rotary vacuum pumps, such as a turbo-molecular pump or a molecular drag pump. The present invention also relates to a rotary vacuum pump using such a fastening structure.

2. Description of the Related Art

Heretofore, there has been known a turbo-molecular pump for use in discharging gas to produce a high vacuum. The turbo-molecular pump comprises a plurality of rotor blades arranged in a multistage manner, and a plurality of stator blades arranged in a multistage manner and in alternate relation to the respective rotor blades. The rotor blades and the stator blades make up a plurality of turbine blades, wherein the rotor blades are formed in a rotor adapted to be rotationally driven by a motor, and the stator blades are fixed to a base. There has also been known one type of turbo-molecular pump which includes a drag pump stage in addition to the above turbine blades. The drag pump stage comprises a cylindrical portion formed in a lower region of a rotor, and a threaded stator (i.e., a stator having a thread groove formed in an inner surface thereof) disposed adjacent to the cylindrical portion.

In the turbo-molecular pump, the rotor formed with the turbine blades and the cylindrical portion is designed to be rotated at a high speed of several tens of thousands rpm. Thus, if an abnormal disturbance acts on the rotor, the rotor is likely to be brought into contact with a stator (e.g., the threaded stator), and thereby a large impact force is applied to the stator. Moreover, during a high-speed rotation of the rotor, the rotor is constantly subjected to a large centrifugal force. Thus, if the rotor is brought into contact with the stator, or continuously operated under harsh conditions beyond assumptions in a design stage thereof, the rotor is likely to be broken. In this case, due to a larger impact force applied to the stator, a large shearing force will be undesirably applied to a bolt which fastens a pump casing to a body of a target unit that will be subjected to a vacuum.

With a view to avoiding the breakage of the bolt, there has been known a technique of forming a plurality of steps in a bolt hole to increase an inner diameter thereof in a stepwise manner, so as to prevent the shearing force from concentrating on one position, as disclosed, for example, in JP 2003-148388A.

Although this conventional technique is designed to allow the bolt to be brought into contact with a lateral region of an inner peripheral surface of the stepped hole, and plastically deformed so as to absorb an impact force, the stepped hole has difficulty in obtaining a sufficient cushioning effect based on plastic deformation.

### SUMMARY OF THE INVENTION

In view of the above circumstances, it is an object of the present invention to provide a fastening structure capable of preventing breakage of a bolt for fastening a first member to a second member, and damages in the first and second members.

It is another object of the present invention to provide a rotary vacuum pump capable of preventing damages in the rotary vacuum pump itself and a target unit fastened to a gas inlet flange thereof.

In order to achieve the above objects, according to a first aspect of the present invention, there is provided a fastening structure for fastening a first member and a second member by a bolt. The fastening structure comprises a cushioning member which is made of a porous metal material, and disposed to absorb kinetic energy to be transmitted from either one of the first and second members to the other member, while reducing an impact stress to be applied to the bolt.

Preferably, in the fastening structure of the present invention, at least either one of the first and second members is formed with a hole having the bolt inserted therethrough, and the cushioning member is disposed between the bolt and an inner peripheral surface of the hole.

Preferably, the fastening structure of the present invention, the porous metal material is a foamed metal.

According to the second aspect of the present invention, there is provided a rotary vacuum pump comprising: a pump casing having a gas inlet flange formed to be fastened to a target unit through the fastening structure as set forth in the first aspect of the present invention; a rotor provided with rotation-side gas discharge means and disposed inside the pump casing in such a manner as to be rotationally driven at a high speed; and stationary-side gas discharge means disposed inside the pump casing to produce a gas-discharging function in cooperation with the rotation-side gas discharge means.

According to the third aspect of the present invention, there is provided a rotary vacuum pump comprising: a pump casing having a gas inlet flange formed to be fastened to a target unit; a rotor provided with rotation-side gas discharge means and disposed inside the pump casing in such a manner as to be rotationally driven at a high speed; a stationary-side gas discharge means disposed inside the pump casing to produce a gas-discharging function in cooperation with the rotation-side gas discharge means; and a cushioning member which is made of a porous metal material, and disposed between the stationary-side gas discharge means and the pump casing to absorb kinetic energy to be transmitted from the stationary-side gas discharge means to the pump casing, while reducing an impact stress to be applied to the pump casing, when the rotation-side gas discharge means is damaged.

In the fastening structure of the present invention, the cushioning member made of a porous metal material is disposed to absorb kinetic energy to be transmitted from either one of the first and second member to the other member through the bolt, while reducing an impact stress to be applied to the bolt. This makes it possible to prevent breakage of the bolt, and damages in the first and second members.

In the rotary vacuum pump set forth in the second or third aspect of the present invention, the cushioning member makes it possible to prevent damages in the rotary vacuum pump itself and the target unit.

### BRIEF DESCRIPTION OF THE DRAWINGS

FIGS. 1A and 1B schematically show a turbo-molecular pump which employs a fastening structure relative to a target unit, according to one embodiment of the present invention, wherein FIG. 1A is a sectional view of the turbo-molecular pump, and FIG. 1B is a top plan view showing a gas inlet flange of the turbo-molecular pump.

FIG. 2 is a sectional view taken along the line A-A in FIG. 1A, which shows the fastening structure around a bolt hole 14 of the gas inlet flange 13a.

FIG. 3 is a sectional view taken along the line A-A in FIG. 1A, for explaining a function of a cushioning member 30.

FIGS. 4A and 4B are schematic diagrams showing a conventional fastening structure, wherein FIG. 4A shows the fastening structure in a state before receiving an impact force, and FIG. 4B shows the fastening structure in a state after receiving the impact force.

FIG. 5 is a schematic diagram showing a simplified model for explaining absorption of impact energy.

FIG. 6 is a schematic diagram showing a simplified model for discussing reduction in impact stress.

FIG. 7 is a schematic diagram showing one example of modification of the turbo-molecular pump.

FIG. 8 is a schematic diagram showing another example of modification of the turbo-molecular pump.

### DETAILED DESCRIPTION OF THE EMBODIMENTS

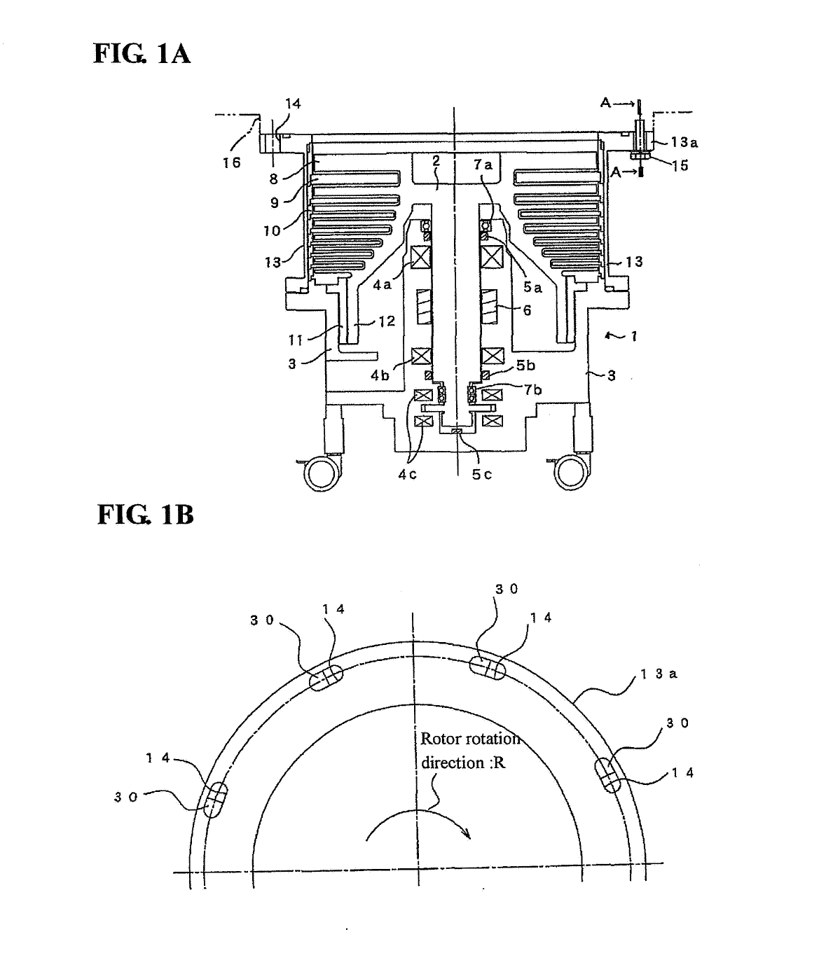

With reference to the drawings, an exemplary embodiment of the present invention will now be described. FIGS. 1A and 1B schematically show a turbo-molecular pump which employs a fastening structure relative to a target unit, according to one embodiment of the present invention, wherein FIG. 1A is a sectional view of the turbo-molecular pump, and FIG. 1B is a top plan view showing an upper half of a gas inlet flange of the turbo-molecular pump. The turbo-molecular pump 1 illustrated in FIGS. 1A and 1B is a magnetic bearing type which has a rotor 2 supported in a non-contact manner by three magnetic bearings 4a to 4c provided in a base 3. Each of the magnetic bearings 4a, 4b is a radial type, and the magnetic bearing 4c is an axial type.

The base 3 is provided with a motor 6 for rotationally driving the rotor 2, and three gap sensors 5a, 5b, 5c for detecting respective levitation positions of two touchdown bearings 7a, 7b and the rotor 2. A mechanical bearing is used for each of the touchdown bearings 7a, 7b to support the rotor 2 when an operation of magnetically levitating the rotor 2 by the magnetic bearings 4a to 4c is deactivated.

The rotor 2 is formed with a plurality of rotor blades 8 arranged in a multistage manner along a direction of a rotation axis. A plurality of stator blades 9 are disposed between vertically-adjacent ones of the rotor blades 8. A turbine blade stage of the turbo-molecular pump 1 is made up of the rotor blades 8 and the stator blades 9. Each of the stator blades 9 is clampedly held by upper and lower spacers 10. In addition to the function of holding the stator blades 9, the spacers 10 have a function of keeping a gap between adjacent ones of the stator blades 9 at a predetermined distance.

A threaded stator 11 is provided as a subsequent stage relative to the stator blades 9 (below the stator blades 9, in FIG. 1A), to form a drag pump stage. The threaded stator 11 has an inner peripheral surface disposed in opposed relation to a cylindrical portion 12 of the rotor 2 with a predetermined distance therebetween. The rotor 2 and the stator blades 9 held by the spacers 10 are housed in a casing 13 formed with a gas inlet flange 13a. As shown in FIG. 1B, the gas inlet flange 13a has eight slot-shaped bolt holes 14 formed at even intervals to allow the gas inlet flange 13a to be fastened by eight bolts 15 to a flange 16 of a target unit to be subjected to a vacuum. Each of the bolt holes 14 is provided with a cushioning member 30 which is a block-shaped member made of foamed metal having a large number of pores. Depending on a diameter of the gas inlet flange 13a, a thickness of the gas inlet flange, a size of the bolt and the number of the bolts are determined according to a standard.

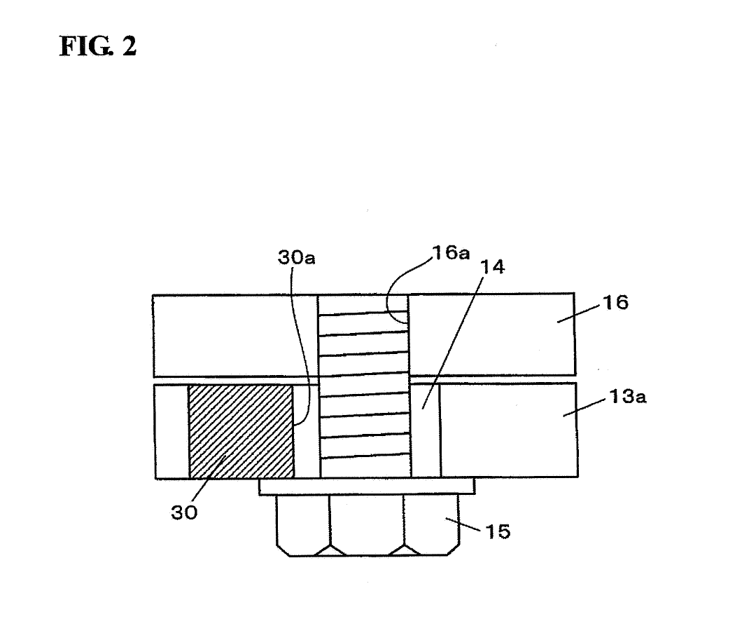

The bolt hole 14 is formed at a position adjacent to an outer peripheral edge of the gas inlet flange 13a in such a manner that a longitudinal direction of the slot-shaped bolt hole 14 approximately conforms to a direction tangential to the circumference of the gas inlet flange 13a. The cushioning member 30 is disposed in the bolt hole 14 in such a manner as to be displaced in a direction opposite to a rotation direction R of the rotor 2, i.e., in a counterclockwise direction in FIG. 1B. FIG. 2 is a sectional view taken along the line A-A in FIG. 1A, which schematically shows the fastening structure around the bolt hole 14 of the gas inlet flange 13a. In FIG. 2, a washer is omitted. A leftward direction in FIG. 2 corresponds to the counterclockwise direction in FIG. 1B. The bolt hole 14 has a space (on a right side in FIG. 2) which is not occupied by the cushioning member 30, and the bolt 15 is inserted into this space. The bolt 15 is screwed with an internally threaded portion 16a of the flange 16 of the target unit (hereinafter referred to as “unit flange 16”).

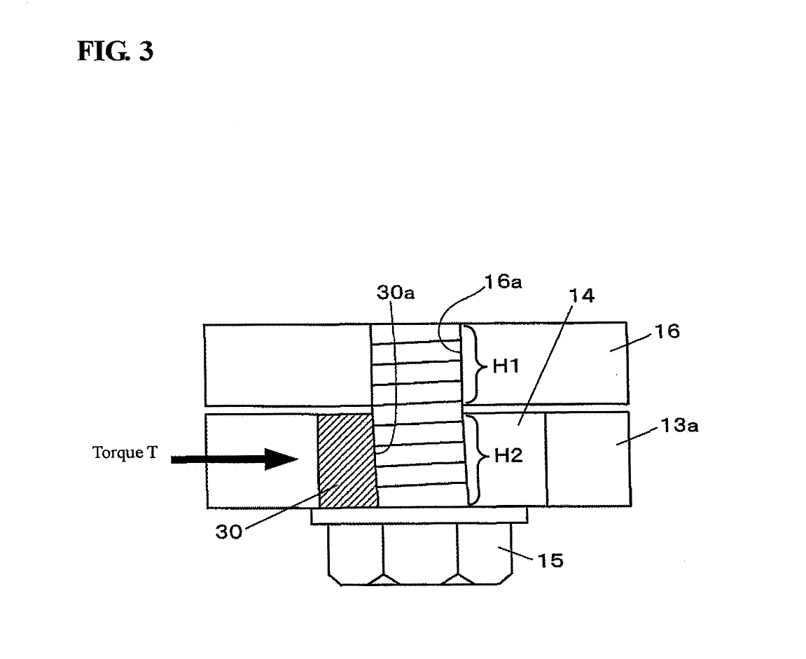

FIG. 3, like FIG. 2, is a sectional view taken along the line A-A in FIG. 1A that is provided for explaining the function of the cushioning member 30. As shown in FIG. 3, a shank of the bolt 15 has a region H1 located on the side of a distal end thereof and screwed with the internally threaded portion 16a of the unit flange 16, and a region H2 which is located on the side of a base end thereof and is not screwed with the unit flange 16. That is, the region H1 is restrained by the unit flange 16, whereas the region R2 is in a non-restrained state.

If the rotor is brought into contact with the stator, or damaged, for some reason, an impact force will be applied to the base 3 and the casing 13 in the rotor rotation direction R. Due to this impact force, a torque T causing a rotation of the gas inlet flange 13a is produced, and the gas inlet flange 13a is rotationally moved in such a manner as to be displaced rightwardly (in FIG. 3) relative to the unit flange 16. According to this rotational movement, a right (in FIG. 3) end surface 30a of the cushioning member 30 will be brought into contact of the shank of the bolt 15.

The impact force to be applied to the base 3 and the casing 13 is extremely large. Thus, even after the cushioning member 30 is brought into contact of the shank of the bolt 15, the gas intake flange 13a is moved rightwardly to compress and deform the cushioning member 30 in the right direction in FIG. 3. This deformation of the cushioning member 30 allows impact energy given to the base 3 and the casing 13 to be absorbed while reducing an impact stress to be transmitted to the bolt 15.

When an impact force is transmitted to the bolt 15 through the cushioning member 30, the shank of the bolt 15 is deformed in such a manner as to be bent rightwardly. Thus, a distance between the region H2 of the shank of the bolt 15 and a left (in FIG. 3) end surface of the bolt hole 14 will become different in a vertical direction in FIG. 3. However, the cushioning member 30 is compressed and deformed in the right (in FIG. 3) direction in conformity to an inclination of the shank of the bolt 15, so that a wide range of the right (in FIG. 3) end surface 30a of the cushioning member 30 can be brought into contact with the shank of the bolt 15. This makes it possible to increase an acting area of the impact stress to be transmitted to the bolt 15.

As above, in this embodiment, the cushioning member 30 made of foamed metal is disposed in the bolt hole 14. Thus, even if an impact force is applied to the base 3 and the casing 13 due to occurrence of an abnormal state in the turbo-molecular pump, the cushioning member 30 can reduce both a shearing force to be applied to the bolt 15 and kinetic energy to be transmitted to the unit flange 16. This makes it possible to prevent breakage of the bolt 15 and deformation/damage of the target unit.

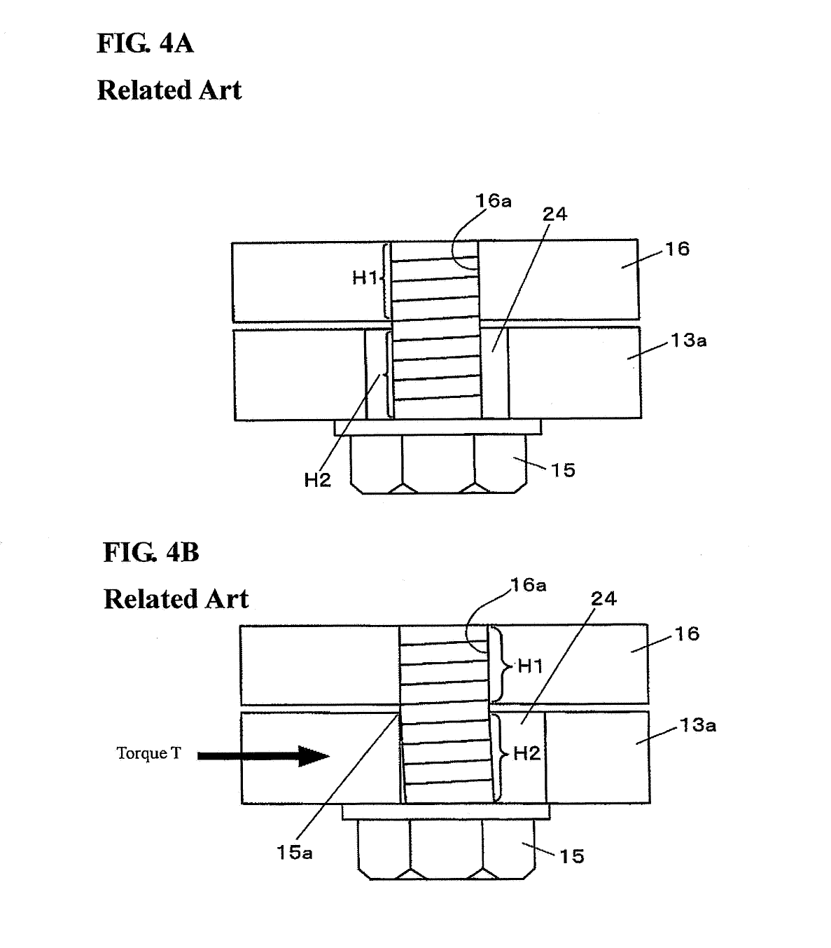

As a comparative example, FIGS. 4A and 4B show a conventional fastening structure, wherein FIG. 4A shows the fastening structure in a state before receiving an impact force, and FIG. 4B shows the fastening structure in a state after receiving the impact force. As shown in FIGS. 4A and 4B, a bolt hole 24 is formed in a gas inlet flange 13a. A shank of a bolt 5 has a region H1 constrained by a flange 16 of a target unit (i.e., unit flange 16), and a region H2 is in a non-restrained state.

If a torque T causing a rotation of the gas inlet flange 13a is produced by the action of an impact force, the gas inlet flange 13a will be rotationally moved in such a manner as to be displaced rightwardly (in FIG. 4A) relative to the unit flange 16. According to this rotational movement, a lateral surface of the bolt hole 24 will be brought into contact with the region H2 of the bolt 15, as shown in FIG. 4B. Thus, the region H2 of the bolt 15 is constrained by the gas inlet flange 13a, and thereby a shearing force is applied to a boarder 15a between the region H1 and region H2 in a concentrated manner. Each of a plurality of bolts 15 fastening the gas inlet flange 13a to the unit flange 16 has the state as shown in FIG. 4B in a different timing due to a positional error between respective ones of the bolt holes 24. That is, only one of the bolts 15 which initially has the state as shown in FIG. 4B is likely to be applied with a shearing force in a concentrated manner, and broken in a moment.

By contrast with the above comparative example, in this embodiment, the positional error between respective ones of the bolt holes 14 can be absorbed based on the deformation of the cushioning members 30 in the respective bolt holes 14, so as to allow the torque T to be received by all of the bolts 15 used for the fastening. This makes it possible to effectively utilize strength of all of the bolts 15 used for the fastening, so as to prevent breakage of the bolts 15.

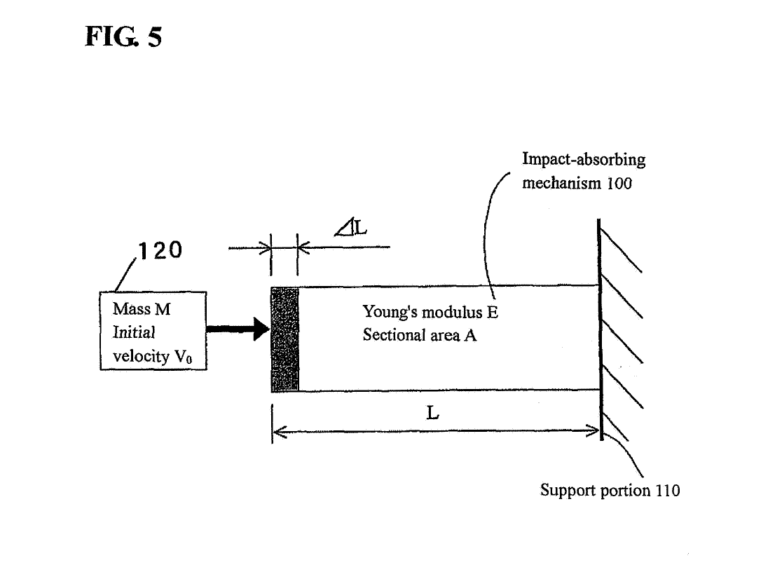

The following description will be made about absorption of impact energy and reduction of an impact stress, based on the cushioning member 30. With reference to a simplified model illustrated in FIG. 5, the absorption of impact energy will first be described. In FIG. 5, the reference numeral 100 indicates an impact-absorbing mechanism for absorbing impact energy. The reference numeral 110 indicates a support portion for supporting the impact-absorbing mechanism 100, and the reference numeral 120 indicates an object which collides with the impact-absorbing mechanism 100. In the following formulas, “L” is a length of the impact-absorbing mechanism 100 in a direction along which the impact energy is applied to the impact-absorbing mechanism 100, and “E” is a Young's modulus of the impact-absorbing mechanism 100. “A” is a sectional area of the impact-absorbing mechanism 100 in a direction perpendicular to the direction of application of the impact energy, and “ΔL” is a deformation amount of the impact-absorbing mechanism 100 due to collision with the object 120. “M” is a mass of the object 120, and “V₀” is an initial velocity before the collision.

Kinetic energy “Eₘ₀” to be applied to the impact-absorbing mechanism 100, and strain energy “Eₑ” of the impact-absorbing mechanism 100 are expressed as the following Formulas (1) and (2), respectively:

Eₘ₀=½×MV₀² (1)

Eₑ=½×Eε²AL (2)

wherein “ε” is a strain of the impact-absorbing mechanism 100 (ε=ΔL/L).

Thus, according to the energy conservation law, kinetic energy “Eₘ₁” to be applied to the support portion 110 is expressed as the following Formula (3):

Eₘ₁=Eₘ₀−Eₑ (3)

An increase in kinetic energy to be absorbed by the impact-absorbing mechanism 100, i.e., the strain energy “Eₑ” is effective in reducing the kinetic energy Eₘ₁ to be applied to the support portion 110.

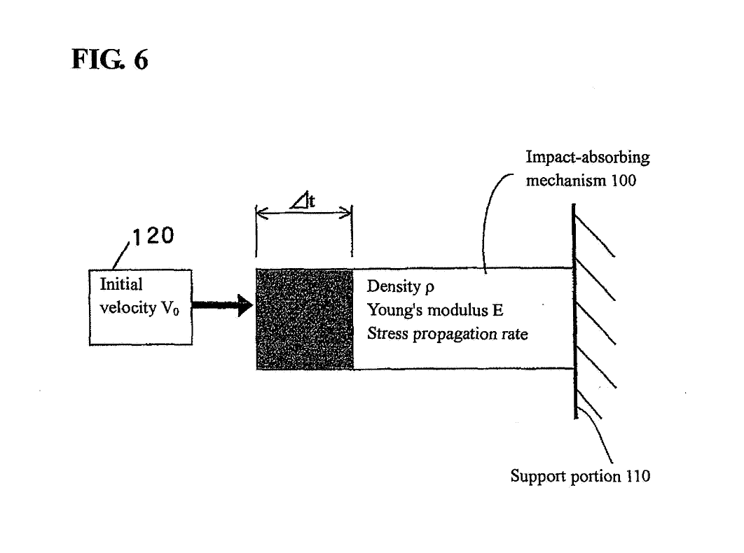

However, if an impact stress applied during deformation of the impact-absorbing mechanism 100 is large, a stress to be applied to the support portion 110 will also be increased. From this point of view, the reduction of impact stress will be discussed with reference to a simplified model illustrated in FIG. 6.

An impulse “I” given to the impact-absorbing mechanism 100 during an elapsed time “Δt” from initiation of the collision with the object 120 is expressed as the following Formula (4):

I=−σAΔt (4)

wherein σ is an impact stress.

Given that a coefficient of restitution between the object 120 and the impact-absorbing mechanism 100, an initial velocity “0” becomes a velocity “V₀” after the elapsed time “Δt” in a zone “C Δt” of the impact-absorbing mechanism 100. A momentum variation ΔP in the zone “C Δt” of the impact-absorbing mechanism 100 is expressed as the following Formula (5):

ΔP=ρACΔtV₀ (5)

wherein ρ is a density of the impact-absorbing mechanism 100, and C is a stress propagation rate of the impact-absorbing mechanism 100.

The impulse “I” given to the impact-absorbing mechanism 100 is equal to the momentum variation ΔP in the impact-absorbing mechanism 100. Thus, the following Formula (6) is derived from the Formulas (4) and (5):

σ=−ρCV₀ (6)

Based on property values of a material, the stress propagation rate “C” can be calculated as the following Formula (7):

C=(E/ρ)^{0.5} (7)

Then, the following Formula (8) is derived from the Formulas (6) and (7):

σ=−V₀(ρE)^{0.5} (8)

According to the Hooke's law, the strain “ε” is expressed as the following Formula (9):

ε=−σ/E (9)

Based on the Formulas (2), (8) and (9), the kinetic energy (strain energy) Eₑ to be absorbed by the impact-absorbing mechanism 100 is expressed as the following Formula (10):

$$\begin{matrix}{E}_{e} = 1 / 2 \times E {ɛ}^{2} AL \\ = EAL / 2 \times {( {V}_{0} {ρ}^{0.5} / {E}^{0.5} )}^{2} \\ = AL ρ {V}_{0}^{2} / 2\end{matrix} \qquad ( 10 )$$

In view of the above discussion, it is desirable to design the impact-absorbing mechanism 100 in such a manner as to reduce the impact stress “σ” expressed by the Formula (8). It is also desirable to design the impact-absorbing mechanism 100 in such a manner as to increase the kinetic energy “Eₑ” (expressed by the Formula (10)) to be absorbed by the impact-absorbing mechanism 100 (hereinafter referred to simply as “absorbable energy Eₑ”). Thus, the impact-absorbing mechanism 100 is designed as follows:
(1) The sectional area “A” and/or the length “L” of the impact-absorbing mechanism 100 is increased;
(2) A material having a low Young's modulus “E” is used; and
(3) The density “ρ” is adjusted at an optimum value.

The above desirable design concept for the impact-absorbing mechanism 100 can be applied to the cushioning member 30 as follows. As to the point (1), a contact area between the cushioning member 30 and the bolt 15 may be increased to ensure the above sectional area “A” so as to allow an impact stress to be sufficiently dispersed. As mentioned above, when the cushioning member 30 is compressed, the cushioning member 30 is deformed in the right direction in FIG. 3 in conformity to the inclination of the shank of the bolt 15. Thus, a wide range of the right (in FIG. 3) end surface 30a of the cushioning member 30 can be brought into the shank of the bolt 15 to ensure the above sectional area “A”.

The points (2) and (3) are dependent on property values of a material to be used for the cushioning member 30. The density “ρ” is desirable to be set at a relatively small value in view of the impact stress “σ”, and to be set at a relatively large in view of the absorbable energy Eₑ. Thus, it is contemplated to select the material in such a manner as to increase the density “ρ” while reducing the impact stress “σ” in a range capable of preventing breakage of the bolt 15. Specifically, the density “ρ” is preferably maximized in the range satisfying the following Formula (11):

σ=−V₀(ρE)^{0.5}<(a breaking stress of the bolt 15)/(safety factor) (11)

The cushioning member 30 is made of foamed metal, as mentioned above. Thus, the density “ρ” of the cushioning member 30 can be changed in a pseudo manner by adjusting a porosity of foamed metal to be used as a material of the cushioning member 30. The density “ρ” of the cushioning member 30 is calculated by multiplying a density of a material of the foamed metal by a porosity of the foamed metal. Thus, the material of the foamed metal and the porosity of the foamed metal can be appropriately changed to set each of the Young's modulus “E” and the density “ρ” of the cushioning member 30, at a desired value, so as to allow the cushioning member 30 to have desirable characteristics in view of the impact stress “σ” and the absorbable energy “Eₑ”. This cushioning member 30 can be used for effectively reducing both a shearing force to be applied to the bolt 15 and kinetic energy to be transmitted to the unit flange 16.

The turbo-molecular pump employing the above fastening structure has the following advantages:
(1) The fastening structure is designed to receive an impact force to be applied from the gas inlet flange 13a to the bolt 15, by the cushioning member 30. This makes it possible to reduce both a shearing force to be applied to the bolt 15 and kinetic energy to be transmitted to the unit flange 16, so as to prevent breakage of the bolt 15 and damages in the target unit, in a simple structure;
(2) The cushioning member 30 is disposed in the bolt hole 14 of the gas inlet flange 13a. Thus, the fastening structure can be obtained only by forming a slot-shaped bolt hole 14 in the gas inlet flange 13a and arranging the cushioning member 30 in the bolt hole 14. This makes it possible to facilitate implementation of the present invention while suppressing an increase in cost. In addition, the present invention can be applied to an existing turbo-molecular pump at a low cost;
(3) The cushioning member 30 is made of foamed metal. Thus, a pseudo-density “ρ” of the cushioning member 30 can be readily adjusted by changing a porosity of the foamed metal. The cushioning member having an appropriately selected porosity can be used for effectively reducing both a shearing force to be applied to the bolt 15 and kinetic energy to be transmitted to the unit flange 16. In addition, the cushioning member 30 having a simple structure formed of the block-shaped foamed metal allows the shearing force to be applied to the bolt 15 and the kinetic energy to be transmitted to the unit flange 16, to be reduced with high reliability and at low cost;
(4) The cushioning member 30 is compressed and deformed in conformity to an inclination of the shank of the bolt 15, so that a wide range of the end surface 30a of the cushioning member 30 can be brought into contact with the shank of the bolt 15. This makes it possible to ensure an acting area of an impact stress to be transmitted from the cushioning member 30 to the bolt 15 so as to disperse the impact stress and increase absorbable energy Eₑ to effectively prevent breakage of the bolt 15 and damages of the target unit; and
(5) A material and/or a porosity of foamed metal for the cushioning member 30 can be appropriately changed to control each of the absorbable energy “Eₑ” and the impact stress “σ”, so as to facilitate design of the cushioning member 30. This also makes it possible to appropriately design the cushioning member 30 depending on a turbo-molecular pump and a target unit so as to allow the present invention to be widely applied.

An exemplary embodiment of the invention has been shown and described. It is obvious to those skilled in the art that various changes and modifications may be made therein without departing from the spirit and scope thereof as set forth in appended claims. For example, while the cushioning member in the above embodiment is made of foamed metal, the cushioning member 30 for use in the present invention is not limited to the foamed metal, but may be made of any other suitable porous metal material, such as a porous metal material prepared by sintering powder or granular metal without a foaming process.

In the above embodiment, the cushioning member 30 is disposed in the bolt hole 14 of the gas inlet flange 13a. Alternatively, the cushioning member 30 may be disposed in a slot-shaped hole formed in the unit flange 16, and the bolt 15 may be screwed with an internally threaded portion formed in the gas inlet flange 13a.

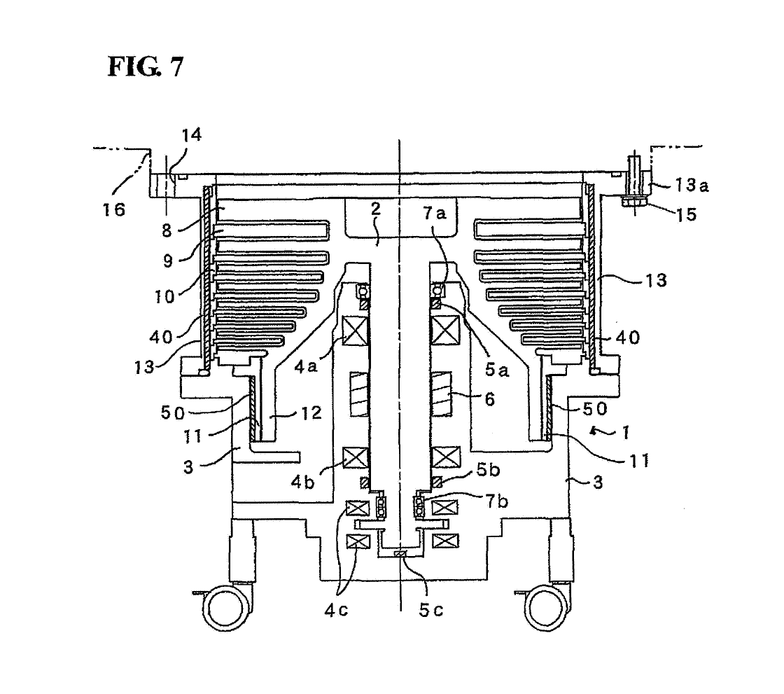

In the above embodiment, the cushioning member 30 is disposed in the fastening portion between the gas inlet flange 13a and the unit flange 16 to reduce a shearing force to be applied to the bolt 15 and kinetic energy to be transmitted to the unit flange 16. Alternatively, as shown in FIG. 7, in order to reduce an impact force to be applied to the base 3 and the casing 13 due to contact between the rotor and the stator or breakage of the rotor, two cushioning members 40, 50 each made of foamed metal may be disposed between the group of spacers 10 and the casing 13 and between the threaded stator 11 and the base 3, respectively.

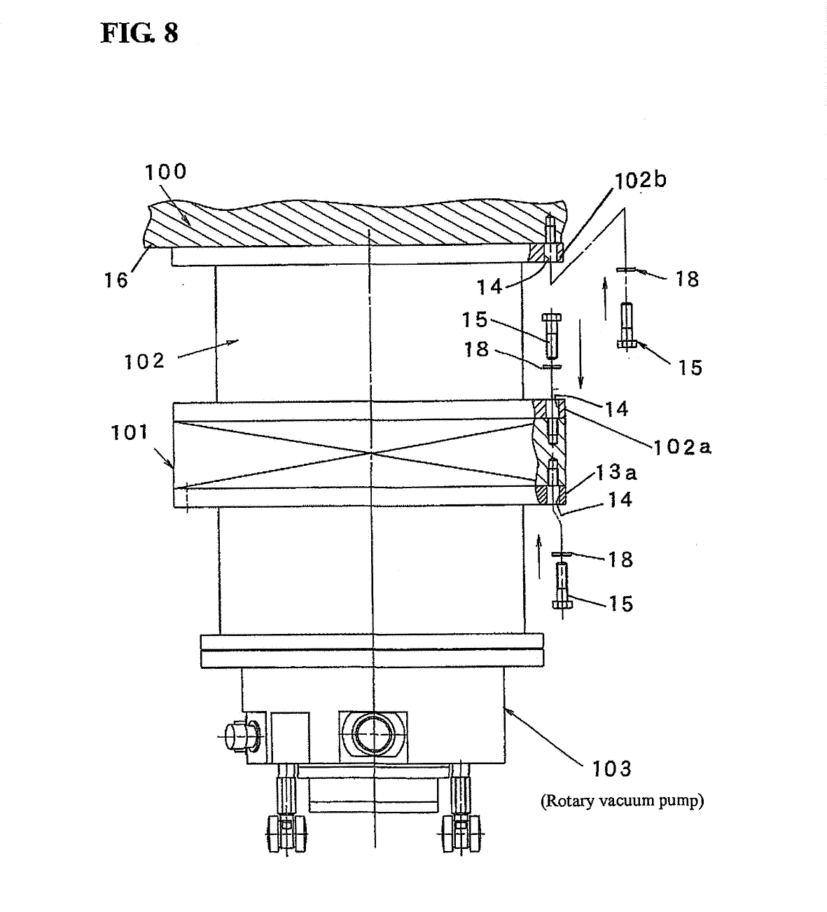

In the above embodiment, the turbo-molecular pump 1 is directly connected to the target unit. As shown in FIG. 8, when a rotary vacuum pump 103, such as a turbo-molecular pump 1 or a molecular drag pump, is attached to a vacuum chamber 100 as a target unit, the rotary vacuum pump 103 is fixed to the vacuum chamber 100 through a valve 101, such as a gate valve or a control valve, in many cases, wherein the valve 101 is fixed to the vacuum chamber 100 through a piping system 102. In this case, the aforementioned fastening structure may be used in respective fastening potions between the rotary vacuum pump 103 and the valve 101, between the valve 101 and the piping system 102, and between piping system 102 and the vacuum chamber 100. Specifically, the aforementioned slot-shaped bolt hole 14, into which the bolt 15 and a washer 18 are inserted, may be formed in each of a gas inlet flange 13a of the rotary vacuum pump 103 and two flanges 102a, 102b of the piping system 102, and the cushioning member 30 may be disposed in each of the bolt holes 14 to obtain the same advantages as those in the above embodiment.

Further, one or more of these modifications may be implemented in combination with the above embodiment.

In the above embodiment and the modifications, the casing 13 corresponds to a pump casing, and each of the stator blades 9 and the threaded stator 11 corresponds to a stationary-side gas discharge means. The above embodiment has been described by way of example, and the present invention shall be interpreted without any limitation and restriction by a correspondence between respective descriptions of the above embodiment and the appended claims.

What is claimed is:

1. A fastening structure for fastening a first member and a second member by a bolt said fastening structure comprising:
a cushioning member which is made of a porous metal material, and disposed to absorb kinetic energy to be transmitted from either one of said first and second members to the other member, while reducing an impact stress to be applied to said bolt.

2. The fastening structure as defined in claim 1, wherein:
at least either one of said first and second members is formed with a hole having said bolt inserted therethrough; and
said cushioning member is disposed between said bolt and an inner peripheral surface of said hole.

3. The fastening structure as defined in claim 1, wherein said porous metal material is a foamed metal.

4. A rotary vacuum pump comprising:
a pump casing having a gas inlet flange formed to be fastened to a target unit through the fastening structure as defined in claim 1;
a rotor provided with rotation-side gas discharge means and disposed inside said pump casing in such a manner as to be rotationally driven at a high speed; and
stationary-side gas discharge means disposed inside said pump casing to produce a gas-discharging function in cooperation with said rotation-side gas discharge means.

5. A rotary vacuum pump comprising:
a pump casing having a gas inlet flange formed to be fastened to a target unit;
a rotor provided with rotation-side gas discharge means and disposed inside said pump casing in such a manner as to be rotationally driven at a high speed;
a stationary-side gas discharge means disposed inside said pump casing to produce a gas-discharging function in cooperation with said rotation-side gas discharge means; and
a cushioning member which is made of a porous metal material, and disposed between said stationary-side gas discharge means and said pump casing to absorb kinetic energy to be transmitted from said stationary-side gas discharge means to said pump casing, while reducing an impact stress to be applied to said pump casing, when said rotation-side gas discharge means is damaged.

6. The fastening structure as defined in claim 2, wherein said porous metal material is a foamed metal.

7. A rotary vacuum pump comprising:
a pump casing having a gas inlet flange formed to be fastened to a target unit through the fastening structure as defined in claim 2;
a rotor provided with rotation-side gas discharge means and disposed inside said pump casing in such a manner as to be rotationally driven at a high speed; and
stationary-side gas discharge means disposed inside said pump casing to produce a gas-discharging function in cooperation with said rotation-side gas discharge means.

8. A rotary vacuum pump comprising:
a pump casing having a gas inlet flange formed to be fastened to a target unit through the fastening structure as defined in claim 3;
a rotor provided with rotation-side gas discharge means and disposed inside said pump casing in such a manner as to be rotationally driven at a high speed; and
stationary-side gas discharge means disposed inside said pump casing to produce a gas-discharging function in cooperation with said rotation-side gas discharge means.

9. A rotary vacuum pump comprising:
a pump casing having a gas inlet flange formed to be fastened to a target unit through the fastening structure as defined in claim 6;
a rotor provided with rotation-side gas discharge means and disposed inside said pump casing in such a manner as to be rotationally driven at a high speed; and
stationary-side gas discharge means disposed inside said pump casing to produce a gas-discharging function in cooperation with said rotation-side gas discharge means.
